(19) United States
(12) Patent Application Publication
(10) Pub. No.: US 2014/0370457 A1
(43) Pub. Date: Dec. 18, 2014

(54) Tooth Loosening And Removal Apparatus With A Motion Transfer Member

(71) Applicant: Hankookin, Inc., Raleigh, NC (US)

(72) Inventors: James Jiwen Chun, Raleigh, NC (US); Andrew Youngho Chun, Raleigh, NC (US); Angela Soyoung Chun, Raleigh, NC (US); Jennifer Miseong Chun, Raleigh, NC (US)

(73) Assignee: Hankookin, Inc.

(21) Appl. No.: 14/471,003

(22) Filed: Aug. 28, 2014

Related U.S. Application Data
(63) Continuation-in-part of application No. 13/568,573, filed on Aug. 7, 2012.
(60) Provisional application No. 61/521,124, filed on Aug. 8, 2011.

(51) Int. Cl. A61C 1/08; A61C 3/14; A61C 1/10; A61C 1/07; A61C 1/12

(52) U.S. Cl. CPC A61C 1/081; A61C 1/07; A61C 1/12; A61C 1/10; A61C 3/14
USPC 433/117; 433/215

(57) ABSTRACT

An apparatus including a transducer head and a motion transfer member, and a method for rupturing connective tissues that attach a tooth to an alveolar bone socket are provided. The transducer head generates and transfers vibrational and tapping movements to the motion transfer member. The motion transfer member, extending from the transducer head via a neck of a transducer assembly, includes a ball projection and a flexible member. The ball projection connected to a distal end of the neck transfers the generated vibrational and tapping movements received from the transducer head to the tooth. The flexible member housing and surrounding the ball projection contacts a tooth surface and generally conforms to a shape of the tooth to distribute the generated vibrational and tapping movements uniformly in multiple directions on the tooth to rupture the connective tissues and allow the tooth to be loosened and removed from the alveolar bone socket.

### CROSS REFERENCE TO RELATED APPLICATIONS

This application is a continuation-in-part application of non-provisional patent application Ser. No. 13/568,573 titled “Removing Primary Teeth And Loosening Permanent Teeth”, filed in the United States Patent and Trademark Office on Aug. 7, 2012, which claims the benefit of provisional patent application No. 61/521,124 titled “Home Device to Remove Primary and Loosen Permanent Teeth”, filed in the United States Patent and Trademark Office on Aug. 8, 2011. The specifications of the above referenced patent applications are incorporated herein by reference in their entirety.

### BACKGROUND

Every child goes through a process of losing primary teeth or baby teeth that are replaced by permanent teeth as the child grows up. In most cases, when the child begins losing the primary teeth, even though the primary teeth begin to loosen, the connective ligaments are still attached to the roots of the primary teeth. It may take weeks before the primary teeth eventually fall out which causes significant discomfort to the child during the teeth replacement period. Apart from going to a dentist, there has not been an effective, painless home technique or apparatus that can be used to remove the primary teeth without causing significant discomfort to the child.

Conventional methods and devices for extracting teeth typically use strong torque and pulling forces to dislodge a root of a tooth from a bone socket. These extraction procedures cause pain, bleeding, and trauma to the surrounding gingival and bone structures. Furthermore, the strong pulling forces or vibrations used to extract the tooth are not uniformly distributed towards the connective tissues causing uneven breakage of the connective tissues. Therefore, a portion of the connective tissues are broken while another portion of the connective tissues are left intact. Upon further application of force, the intact connective tissues experience a larger force and cause severe pain in the patient's mouth. Although dentists use local anesthetics to reduce the pain and discomfort during the extraction procedure, many children are still afraid of going to the dentist to have their primary teeth removed due to the fear and anxiety of pain and discomfort involved in the extraction procedure.

Hence, there is a long felt but unresolved need for a method and an apparatus that uniformly ruptures connective tissues that attach a tooth to an alveolar bone socket of a patient to allow the tooth to be dislodged from the alveolar bone socket while causing minimal pain and minimal discomfort to the patient.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method and apparatus disclosed herein address the above stated need for rupturing connective tissues that attach a tooth to an alveolar bone socket of a patient, and as a result allow the tooth to be dislodged from the alveolar bone socket with minimal pain and minimal discomfort to the patient. The apparatus disclosed herein comprises a metal cap generally shaped like a crown of the tooth, and a transducer assembly. The metal cap is removably attached to the tooth using a cementing agent. The cementing agent comprises, for example, a rigid, biologically safe, and quick setting dental cement that secures the metal cap firmly to the tooth.

The metal cap comprises a body section and a ball socket. The body section of the metal cap comprises a coronal surface and multiple generally contiguous vertical surfaces that define a hollow space within the body section for enclosing the tooth. The generally contiguous vertical surfaces are closed surfaces. The metal cap is, for example, made of a soft metal alloy or a rigid metal, and shaped to custom fit each type of primary teeth up to a gum line of the patient. In an embodiment, the length of the generally contiguous vertical surfaces of the body section of the metal cap is configured to enclose half a length of the tooth towards a gum line of the patient, when the metal cap is removably attached to the tooth. In this embodiment, the metal cap is made of a rigid metal, for example, stainless steel. Enclosing only the top half of the tooth enables easy removal of the metal cap at the end of the procedure.

The generally contiguous vertical surfaces of the body section of the metal cap comprise, for example, a buccal surface, a lingual surface, and a pair of opposing inter-tooth surfaces. In an embodiment, the buccal surface and the lingual surface are configured to enclose the tooth up to the gum line of the patient, when the metal cap is removably attached to the tooth, while the opposing inter-tooth surfaces are shaped or clipped to enclose the tooth at half the distance above contact points with adjacent teeth. As used herein, the term “buccal” refers to a direction towards the inside of a cheek and/or lips of the patient, and all elements or components characterized by this term are disposed towards or proximal to the cheek and/or the lips. Also, as used herein, the term “lingual” refers to a direction towards the tongue of the patient, and all elements or components characterized by this term are disposed towards or proximal to the tongue. A dental cement can be used to fasten the metal cap to the tooth. The buccal surface and the lingual surface of the metal cap can be fastened to the body of the tooth with dental forceps before the cement sets hard.

At least one of the generally contiguous vertical surfaces is folded and comprises a slit terminating with an apical strip and loop arrangement. As used herein, the term “apical” refers to a direction towards the root of a tooth, and all elements or components characterized by this term are disposed towards or proximal to the root of the tooth. The apical strip and loop arrangement of the body section of the metal cap secures the metal cap to the tooth. The apical strip and loop arrangement is severed open to remove the metal cap from the tooth. In an embodiment, the apical strip and loop arrangement of the body section of the metal cap is configured as a fold in an apical edge of the body section. The apical edge is soldered at a neck of the fold to form a seal. The soldered seal can be severed, for example, using a specially designed scissor, or a finger nail clipper to remove the metal cap from the tooth.

The ball socket of the metal cap extends from the coronal surface of the body section. In an embodiment, the ball socket is an enclosed shell that produces a pull force to pull the tooth vertically from the alveolar bone socket. The ball projection is inserted into the ball socket from the side and locked inside the ball socket. This type of metal cap is made, for example, using stainless steel, and can be sterilized for reuse.

The transducer assembly of the apparatus disclosed herein comprises a transducer head and a ball projection extending from the transducer head. The ball projection extends from the transducer head, for example, in a linear configuration, a curved configuration, an angled configuration, etc. The transducer head is configured to generate vibrational and tapping movements in the ball projection at a predetermined frequency which causes minimal pain and minimal discomfort to the patient. During a tooth removal procedure or a tooth loosening procedure, the ball projection of the transducer assembly is configured to operatively engage the ball socket of the metal cap to transfer the generated vibrational and tapping movements to the removably attached metal cap and thereby to the tooth. The vibrational and tapping movements transferred to the tooth by the transducer assembly rupture the connective tissues that attach the tooth to the alveolar bone socket of the patient to allow the tooth to be dislodged or removed from the alveolar bone socket.

Also, disclosed herein is a method for rupturing connective tissues that attach a tooth to an alveolar bone socket of a patient. The metal cap and the transducer assembly of the apparatus disclosed herein are provided. The metal cap is removably attached to the tooth using a cementing agent. The transducer head of the transducer assembly generates vibrational and tapping movements in the ball projection at a predetermined frequency. The ball projection of the transducer assembly operatively engages with the ball socket of the removably attached metal cap for transferring the generated vibrational and tapping movements to the removably attached metal cap and thereby to the tooth. The vibrational and tapping movements transferred to the tooth by the transducer assembly ruptures the connective tissues that attach the tooth to the alveolar bone socket of the patient, thereby allowing the tooth to be readily removed from the alveolar bone socket with minimal force.

In an embodiment, the apparatus for uniformly rupturing connective tissues that attach a tooth to an alveolar bone socket comprises a transducer head and a motion transfer member. The transducer head generates vibrational and tapping movements, and transfers the generated vibrational and tapping movements to the motion transfer member via a neck of the transducer assembly. The motion transfer member extends from the transducer head via the neck of the transducer assembly. The motion transfer member comprises a ball projection and a flexible member of a predefined shape, for example, a generally spherical shape, a generally cylindrical shape, etc. The ball projection is operably connected to a distal end of the neck that extends from the transducer head. The ball projection transfers the generated vibrational and tapping movements received from the transducer head to the tooth. The flexible member is made of a foam based material or a non-foam based material. The flexible member houses and surrounds the ball projection. The flexible member is configured to contact a surface of the tooth and generally conform to a shape of the tooth to distribute the generated vibrational and tapping movements received from the ball projection, uniformly in multiple directions on the tooth. The uniformly distributed vibrational and tapping movements on the tooth rupture the connective tissues that attach the tooth to the alveolar bone socket to allow the tooth to be loosened and removed from the alveolar bone socket.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing carries over to the description of that method step or structure shown by that same numeral in any subsequent drawing herein.

FIG. 1A illustrates a disassembled view of an apparatus for rupturing connective tissues that attach a tooth to an alveolar bone socket of a patient.

FIG. 1B exemplarily illustrates an assembled view of the apparatus for rupturing connective tissues that attach a tooth to an alveolar bone socket of a patient.

FIG. 2A exemplarily illustrates a bottom perspective view of a metal cap of the apparatus.

FIG. 2B exemplarily illustrates a side elevation view of the metal cap.

FIG. 2C exemplarily illustrates a front elevation view of the metal cap.

FIG. 3A exemplarily illustrates a bottom perspective view of an embodiment of the metal cap.

FIG. 3B exemplarily illustrates a side elevation view of the embodiment of the metal cap.

FIG. 3C exemplarily illustrates a front elevation view of the embodiment of the metal cap.

FIG. 4A exemplarily illustrates a bottom perspective view of another embodiment of the metal cap.

FIG. 4B exemplarily illustrates a side elevation view of the embodiment of the metal cap.

FIG. 4C illustrates a front elevation view of the embodiment of the metal cap.

FIG. 5A exemplarily illustrates a perspective view of an embodiment of a ball socket of the metal cap.

FIG. 5B exemplarily illustrates a front elevation view of the embodiment of the ball socket of the metal cap.

FIG. 5C exemplarily illustrates a side elevation view of the embodiment of the ball socket of the metal cap.

FIG. 5D exemplarily illustrates a top view of the embodiment of the ball socket of the metal cap.

FIG. 6A exemplarily illustrates a side view of a transducer assembly of the apparatus, showing a ball projection extending from a transducer head of the transducer assembly in a linear configuration.

FIG. 6B exemplarily illustrates a side view of a transducer assembly of the apparatus, showing a ball projection extending from a transducer head of the transducer assembly in a curved configuration.

FIG. 6C exemplarily illustrates a side view of a transducer assembly of the apparatus, showing a ball projection extending from a transducer head of the transducer assembly in an angled configuration.

FIG. 7 illustrates a method for rupturing connective tissues that attach a tooth to an alveolar bone socket of a patient.

FIG. 8 exemplarily illustrates application of a cementing agent on a tooth using a mixing syringe.

FIG. 9 exemplarily illustrates a perspective view of an embodiment of the apparatus for rupturing connective tissues that attach a tooth to an alveolar bone socket.

FIG. 10 exemplarily illustrates a partially disassembled view of the embodiment of the apparatus shown in FIG. 9.

FIGS. 11A-11B exemplarily illustrate enlarged views of a motion transfer member of the embodiment of the apparatus shown in FIG. 9, showing connection of the ball projection to a flexible member of the motion transfer member.

FIG. 11C exemplarily illustrates an enlarged view showing uniform distribution of vibrational movements on a tooth by the motion transfer member of the embodiment of the apparatus shown in FIG. 9.

FIG. 12A exemplarily illustrates a side view of the embodiment of the apparatus shown in FIG. 9, showing the motion transfer member extending from the transducer head in a linear configuration.

FIG. 12B exemplarily illustrates a side view of the embodiment of the apparatus shown in FIG. 9, showing the motion transfer member extending from the transducer head in a curved configuration.

FIG. 12C exemplarily illustrates a side view of the embodiment of the apparatus shown in FIG. 9, showing the motion transfer member extending from the transducer head in an angled configuration.

FIG. 13 exemplarily illustrates a partial perspective view of an embodiment of the motion transfer member of the apparatus shown in FIG. 9.

FIG. 14 exemplarily illustrates deposition of an adhesive material on a surface of a tooth using a mixing syringe prior to removal of the tooth.

FIG. 15 exemplarily illustrates a perspective view of the embodiment of the apparatus shown in FIG. 9, operably connected to the tooth to rupture the connective tissues that attach the tooth to an alveolar bone socket.

FIG. 16 illustrates an embodiment of the method for rupturing connective tissues that attach a tooth to an alveolar bone socket.

### DETAILED DESCRIPTION OF THE INVENTION

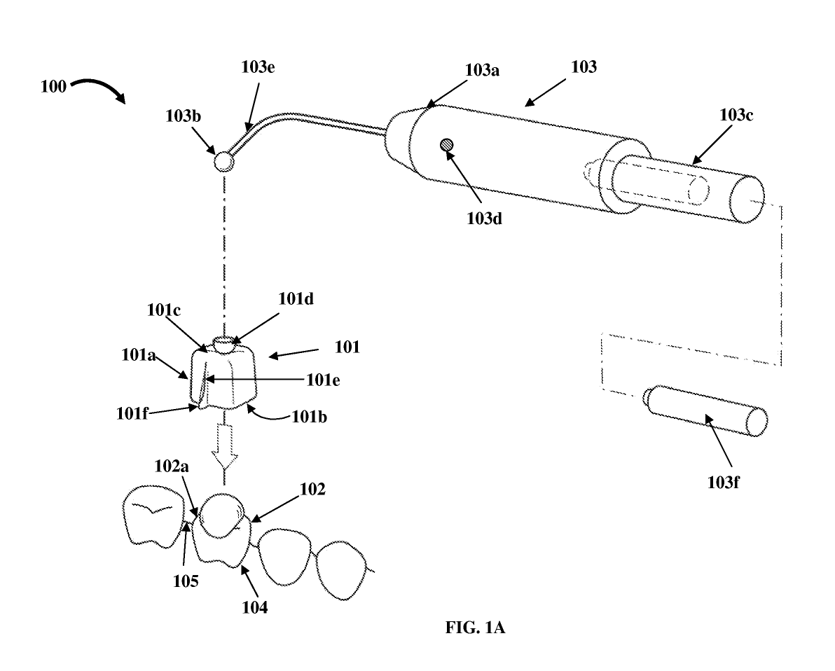

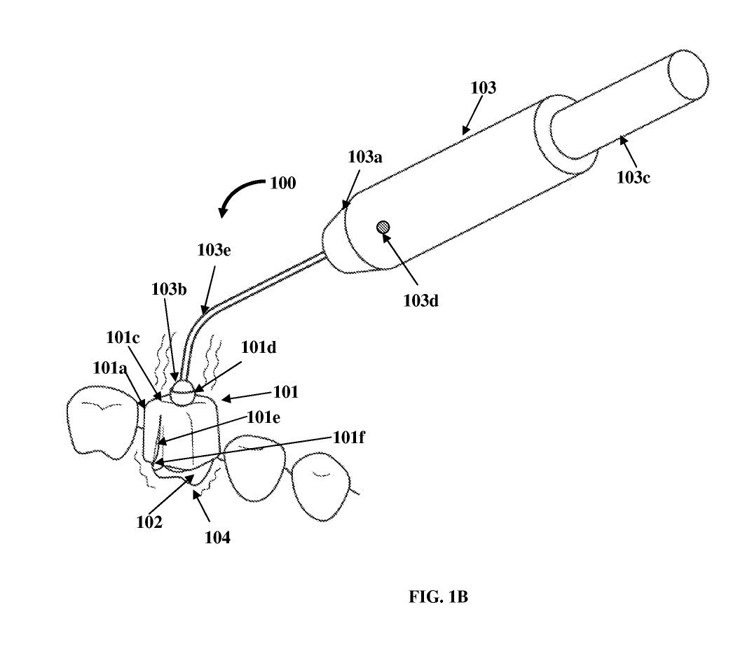

FIG. 1A illustrates a disassembled view of an apparatus 100 for rupturing connective tissues that attach a tooth 102 to an alveolar bone socket 104 of a patient. FIG. 1B exemplarily illustrates an assembled view of the apparatus 100 for rupturing the connective tissues that attach a tooth 102 to the alveolar bone socket 104 of the patient. The apparatus 100 disclosed herein ruptures connective tissues, for example, periodontal ligaments that attach the tooth 102 to the alveolar bone socket 104, and as a result allows the tooth 102 to be readily dislodged from the alveolar bone socket 104 with minimal pain and minimal discomfort to the patient. The apparatus 100 disclosed herein comprises a metal cap 101 generally shaped like a crown 102a of the tooth 102, and a transducer assembly 103. In an embodiment, the metal cap 101 is of an open cubical shape. The metal cap 101 is removably attached to the tooth 102 using a cementing agent 802 exemplarily illustrated in FIG. 8. The cementing agent 802 comprises, for example, a rigid, biologically safe, and quick setting dental cement that secures the metal cap 101 firmly to the tooth 102. The cementing agent 802 is, for example, the Zone translucent temporary dental cement manufactured by Dux Dental® of Dux Industries, Inc.

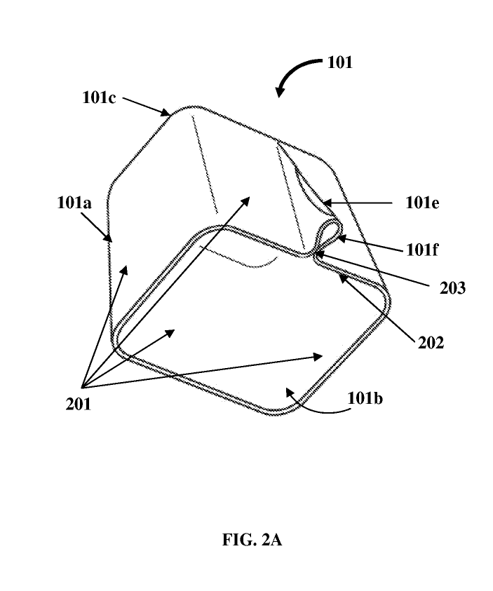

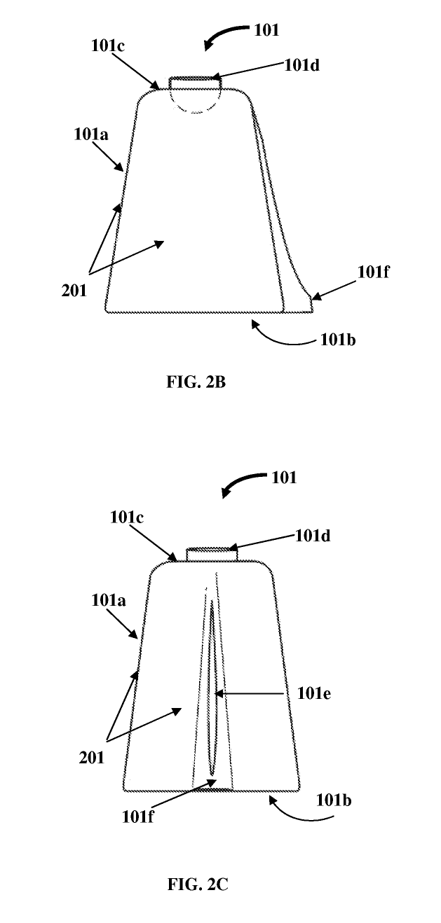

The metal cap 101 comprises a generally rectangular body section 101a. The body section 101a comprises a coronal surface 101c and multiple generally contiguous vertical surfaces 201 that define a hollow space 101b within the body section 101a for enclosing the tooth 102 as exemplarily illustrated in FIGS. 2A-2C. As used herein, the term “coronal” refers to a direction towards the crown 102a of a tooth 102, and all elements or components characterized by this term are disposed towards or proximal to the crown 102a of the tooth 102. The generally contiguous vertical surfaces 201 are closed surfaces. FIG. 2A exemplarily illustrates a bottom perspective view of the metal cap 101. FIG. 2B exemplarily illustrates a side elevation view of the metal cap 101. FIG. 2C exemplarily illustrates a front elevation view of the metal cap 101. At least one of the generally contiguous vertical surfaces 201 is folded and comprises a slit 101e terminating with an apical strip and loop arrangement 101f. As used herein, the term “apical” refers to a direction towards the root of a tooth 102, and all elements or components characterized by this term are disposed towards or proximal to the root of the tooth 102. The metal cap 101 further comprises a ball socket 101d extending from the coronal surface 101c of the body section 101a. The metal cap 101 is made of a soft metal alloy, for example, containing aluminum, or a rigid metal, and shaped to custom fit each type of primary teeth 102 up to a gum line 105 of the patient.

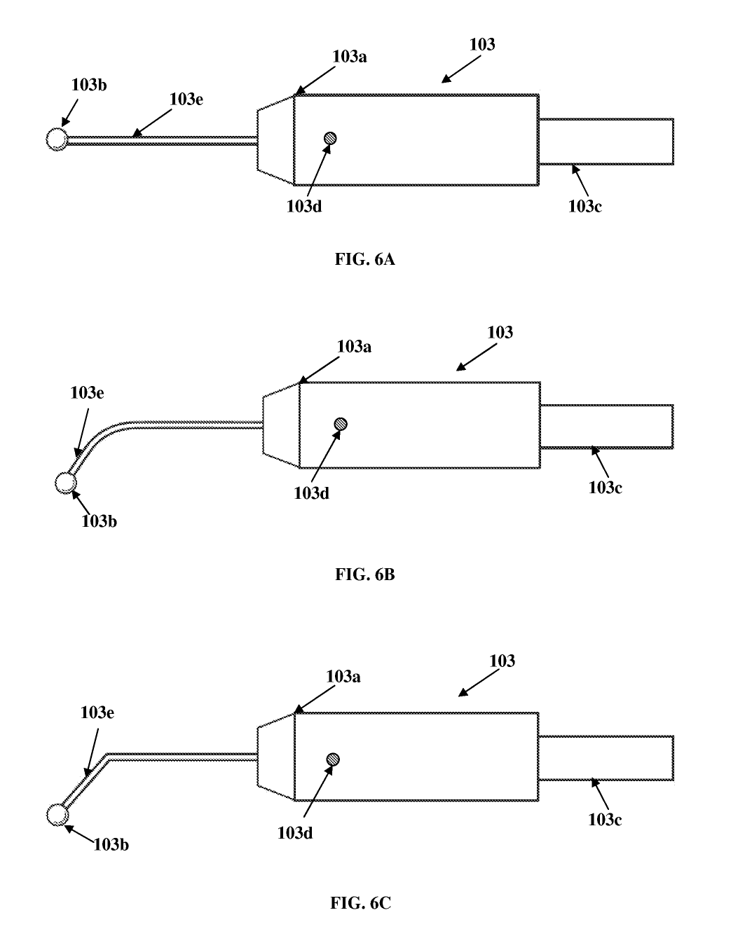

As exemplarily illustrated in FIGS. 1A-1B, the transducer assembly 103 of the apparatus 100 disclosed herein comprises a transducer head 103a, a ball projection 103b extending from the transducer head 103a via a neck 103e, and a battery compartment 103c that stores a battery 103f. The battery 103f powers the transducer head 103a. The ball projection 103b extends from the transducer head 103a, for example, in a linear configuration as exemplarily illustrated in FIG. 6A, or in a curved configuration as exemplarily illustrated in FIG. 6B, or in an angled configuration as exemplarily illustrated in FIG. 6C. The transducer head 103a is configured to generate vibrational and tapping movements in the ball projection 103b, the amplitude and frequency of which can be varied. During a tooth removal procedure or a tooth loosening procedure, the ball projection 103b extending from the neck 103e of the transducer assembly 103 operatively engages the ball socket 101d of the metal cap 101 to transfer the generated vibrational and tapping movements to the removably attached metal cap 101 and thereby to the tooth 102 enclosed by the metal cap 101. The vibrational and tapping movements transferred to the tooth 102 by the transducer assembly 103 ruptures the connective tissues that attach the tooth 102 to the alveolar bone socket 104 of the patient to allow the tooth 102 to be removed from the alveolar bone socket 104. In an embodiment, the transducer assembly 103 is configured to generate the vibrational and tapping movements at a predetermined frequency which causes minimal pain and minimal discomfort to the patient.

The transducer head 103a of the transducer assembly 103 is configured to produce acoustic vibrations or ultrasonic vibrations. In an embodiment, the transducer head 103a is configured with a magnetostrictive transducer that applies a property of magnetostriction for producing acoustic vibrations. Magnetostriction utilizes the property of ferromagnetic materials, for example, iron, nickel, cobalt, etc., and their alloys, that causes them to change their physical properties during the process of magnetization. The magnetostriction transducer converts magnetic energy into kinetic energy and vice versa, and creates the acoustic vibrations.

In another embodiment, the transducer head 103a is configured with a piezoelectric transducer that produces acoustic vibrations or ultrasonic vibrations. Electrostriction is a property of electrical non-conductors or dielectrics, for example, lead magnesium niobate, lead magnesium niobate-lead titanate, lead lanthanum zirconate titanate, etc., that causes them to change their physical properties under the application of an electric field. The piezoelectric transducer utilizes a converse piezoelectric effect of dielectrics and converts electrical energy to acoustic energy and vice versa.

The transducer assembly 103 disclosed herein configured as a magnetostrictive transducer or a piezoelectric transducer produces vibrations with an acoustic range of, for example, about 20 Hz to about 20 kHz and an ultrasonic range of about 20 kHz to about 45 kHz. To avoid heat buildup during vibration, intervals are built in between the pulses of vibrations. The transducers that may be used in the transducer head 103a include, for example, transducers operating with an optimum frequency of about 516 Hz that are used in electric toothbrushes, transducers operating with an optimum frequency in a range of about 25 kHz to about 35 kHz that are used in dental ultrasonic scalers such as the TurboPIEZO™ ultrasonic scaler of Parkell, Inc., etc. In an example, the transducer which operates at a frequency of about 516 Hz used in the Sonicare® toothbrush of Koninklijke Philips Electronics N.V. Limited Liability Company, Netherlands may be used in the transducer head 103a of the transducer assembly 103. This transducer produces vibrations that can be transferred to the metal cap 101 without causing an unpleasant sensation to the gum or the tooth 102 enclosed by the metal cap 101.

Although the detailed description refers to the transducer head 103a configured with a magnetostrictive transducer or a piezoelectric transducer; the scope of the apparatus 100 disclosed herein is not limited to a magnetostrictive transducer or a piezoelectric transducer but may be extended to include other transducers that produce vibrations, for example, sonic transducers, ultrasonic transducers, etc., and other functionally equivalent transducers.

The apparatus 100 disclosed herein is used to extract a primary tooth 102 when the primary tooth 102 begins to loosen. The transducer assembly 103 is configured to produce a multitude of vibrational movements per second, and the small amount of force transferred to the ball socket 101d of the metal cap 101 is generally sufficient to rupture the connective tissues, for example, periodontal ligaments. For example, if the transducer assembly 103 produces vibrations up to a supersonic frequency of, for example, about 5 kHz to about 35 kHz, the periodontal ligaments are ruptured in a few seconds, and the tooth 102 can be readily removed from the alveolar bone socket 104 with minimal trauma and pain. The apparatus 100 disclosed herein is configured to produce a combination of high frequency vibrational and tapping movements on the tooth 102 to be extracted. These movements are directed downward and sideways around the root of the tooth 102 and correspond to forces that the tooth 102 encounters during normal chewing. These high frequency vibrational and tapping movements cause minimal pain to a patient. The magnitude of the forces applied by the apparatus 100 disclosed herein is light and the frequency of the forces is high such that these forces and the corresponding movement directed downward and sideways around the root of the tooth 102 cause minimal discomfort to the patient.

FIGS. 2A-2C exemplarily illustrate different views of the metal cap 101. The shape of the metal cap 101 generally conforms to the anatomy of the tooth 102, and the hollow space 101b of the metal cap 101 is slightly bigger than the tooth 102 to be extracted to allow the metal cap 101 to fit over the tooth 102. The metal cap 101 is cemented to the tooth 102 and encloses the tooth 102 down to the gum line 105. The method of applying the cementing agent 802 exemplarily illustrated in FIG. 8, to the tooth 102 is disclosed in the detailed description of FIG. 8. In an example, the cementing agent 802 is applied on the inner surfaces of the metal cap 101 and to the crown 102a of the tooth 102, and thereafter the metal cap 101 is positioned and fitted over and around the tooth 102.

The apical strip and loop arrangement 101f of the body section 101a of the metal cap 101 also secures the metal cap 101 to the tooth 102. In an embodiment, one of the generally contiguous vertical surfaces 201 of the metal cap 101 has a partially opened frontal opening or slit 101e and is secured by the apical strip and loop arrangement 101f. The apical strip and loop arrangement 101f can be severed to open up the frontal slit 101e for removing the metal cap 101 from the tooth 102. In an embodiment, the apical strip and loop arrangement 101f of the body section 101a of the metal cap 101 is configured as a fold in an apical edge 202 of the body section 101a. The apical edge 202 of the body section 101a is soldered at a neck of the fold to form a seal 203. The soldered seal 203 is not very rigid and if the apical strip and loop arrangement 101f is cut open, for example, by a finger nail clipper, the soldered seal 203 becomes loose and the frontal slit 101e opens up, enabling easy removal of the metal cap 101 from the tooth 102. The soldered seal 203 can be severed, for example, using a specially designed scissor or a finger nail clipper to remove the metal cap 101 from the tooth 102.

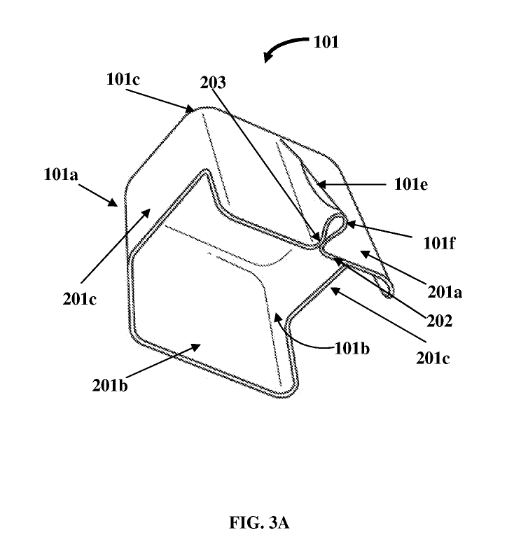

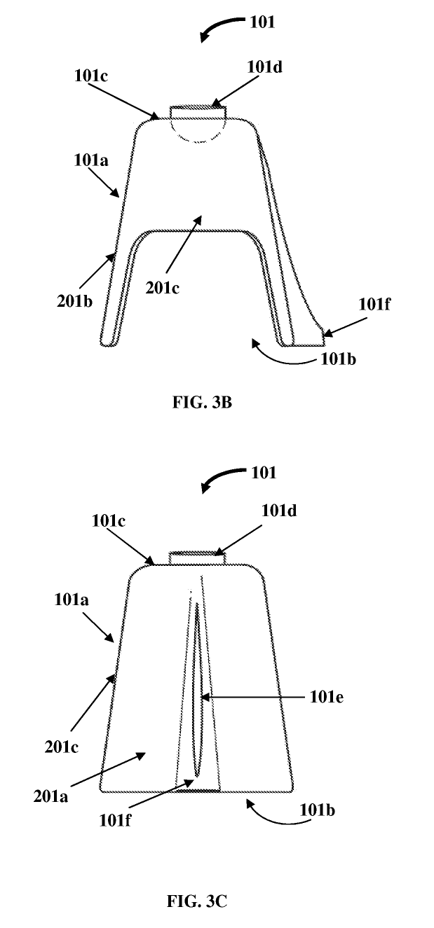

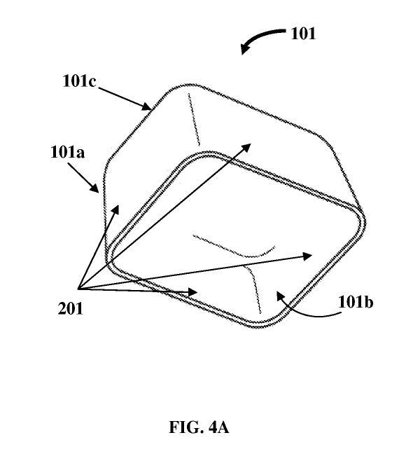

FIG. 3A exemplarily illustrates a bottom perspective view of an embodiment of the metal cap 101. FIG. 3B exemplarily illustrates a side elevation view of the embodiment of the metal cap 101. FIG. 3C exemplarily illustrates a front elevation view of the embodiment of the metal cap 101. The apparatus 100 disclosed herein can also allow dentists to loosen a permanent tooth 102, although a stronger vibrational force may be required to be applied by the apparatus 100 disclosed herein to rupture the connective tissues and allow the permanent tooth 102 to be dislodged and removed. Since stronger forces are required to remove a permanent tooth 102, the material of the metal cap 101 used to remove the permanent tooth 102 comprises a rigid metal, for example, stainless steel. Furthermore, permanent teeth 102 are generally not as loose and movable as primary teeth 102, and hence it is difficult to force fit the metal cap 101 between the permanent teeth 101. The metal cap 101 as exemplarily illustrated in FIGS. 3A-3C is used to remove permanent teeth 102. The generally contiguous vertical surfaces 201 of the body section 101a of the metal cap 101 comprise, for example, a buccal surface 201b, a lingual surface 201a, and a pair of opposing inter-tooth surfaces 201c. As used herein, the term “buccal” refers to a direction towards the inside of a cheek and/or lips of the patient, and all elements or components characterized by this term are disposed towards or proximal to the cheek and/or the lips. Also, as used herein, the term “lingual” refers to a direction towards the tongue of the patient, and all elements or components characterized by this term are disposed towards or proximal to the tongue. Each of the generally contiguous vertical surfaces 201a, 201b, and 201c of the body section 101a of the metal cap 101 is generally perpendicular to an adjacent generally contiguous vertical surface 201a, 201b, or 201c.

In this embodiment, the buccal surface 201b and the lingual surface 201a are configured to enclose the permanent tooth 102 up to the gum line 105 of the patient when the metal cap 101 is removably attached to the tooth 102, while the opposing inter-tooth surfaces 201c are shaped or clipped to enclose the permanent tooth 102 at a height of about half the distance above or towards the contact points between adjacent teeth 102. For purposes of illustration, while this embodiment has been described with reference to the metal cap 101 having a buccal surface 201b, a lingual surface 201a, and a pair of opposing inter-tooth surfaces 201c for a typical molar tooth 102, it is to be understood that the metal cap 101 may be configured in any shape and with any number of surfaces 201 in order to generally conform to the tooth 102 being extracted. For example, the metal cap 101 may be configured in a closed parabolic shape to generally conform to an incisor tooth 102 of the patient. In an embodiment, the buccal surface 201b and the lingual surface 201a are adapted to enclose the tooth 102 up to a gum line 105 of a patient when the metal cap 101 is removably attached to the tooth 102, while the opposing inter-tooth surfaces 201c are clipped below a predefined height of the buccal surface 201b and the lingual surface 201a to enclose the tooth 102 at a height of approximately half a distance from the gum line 105 or around contact points between adjacent teeth 102. The pair of opposing inter-tooth surfaces 201c encloses half the tooth 102 as compared to the buccal surface 201b and the lingual surface 201a. Therefore, the metal cap 101 does not intrude into the space or contact point between adjacent teeth 102, and allows only the tooth 102 that is fit with the metal cap 101 to be loosened and/or removed.

In the embodiment disclosed in the detailed description of FIGS. 3A-3C, the apical strip and loop arrangement 101f may not be required, since dentists can easily remove the metal cap 101 from the tooth 102. Dental cements are used to fasten the metal cap 101 to the body of the tooth 102. As exemplarily illustrated in FIGS. 3A-3C, the buccal surface 201b and the lingual surface 201a can be fastened to the body of the tooth 102 with dental forceps before the dental cement sets hard.

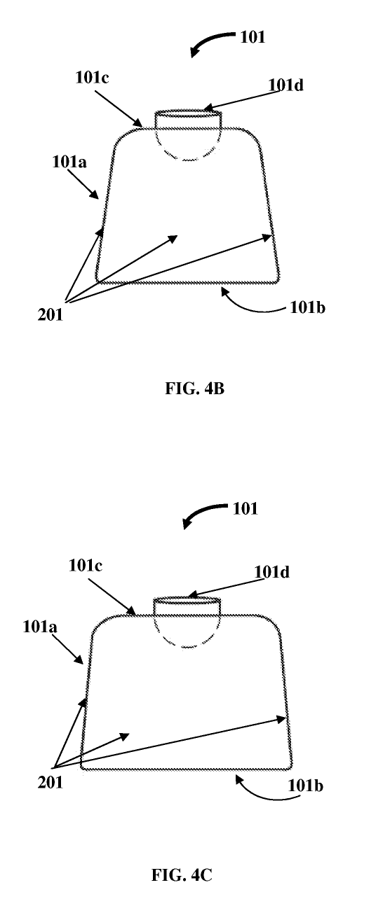

FIG. 4A exemplarily illustrates a bottom perspective view of another embodiment of the metal cap 101. FIG. 4B exemplarily illustrates a side elevation view of this other embodiment of the metal cap 101. FIG. 4C illustrates a front elevation view of this other embodiment of the metal cap 101. In this embodiment, the length of the generally contiguous vertical surfaces 201 of the body section 101a of the metal cap 101 is configured to enclose half the length of the tooth 102 towards the gum line 105 of the patient, when the metal cap 101 is removably attached to the tooth 102. In this embodiment, the metal cap 101 is made of a rigid metal, for example, stainless steel. Enclosing only the top half of the tooth 102 enables easy removal of the metal cap 101 at the end of the tooth removal procedure or the tooth loosening procedure.

A child has 20 primary baby teeth, and all are shaped differently from each other. Although baby teeth for different children may vary slightly in size, the shape is remarkably similar in children of all races. The removable metal cap 101 is custom made for each type of teeth. The metal caps 101 can be sold as a complete set for the entire dentition or for an individual tooth 102. The metal caps 101 are for single use and disposable. Instructions with pictures or video may assist parents to identify the correct metal cap 101 for each tooth 102.

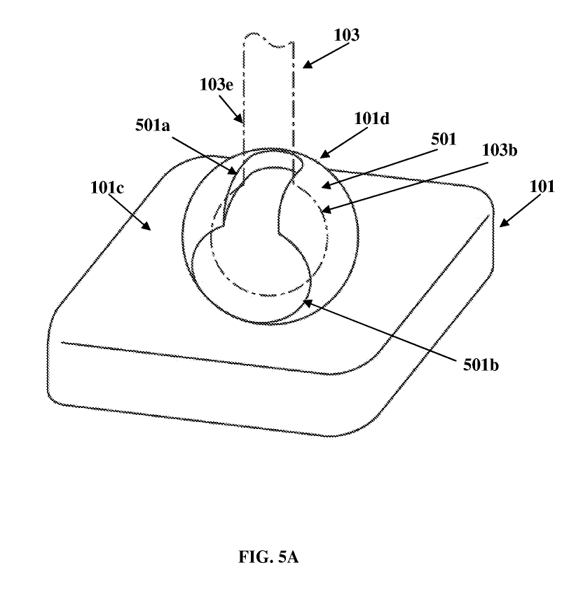

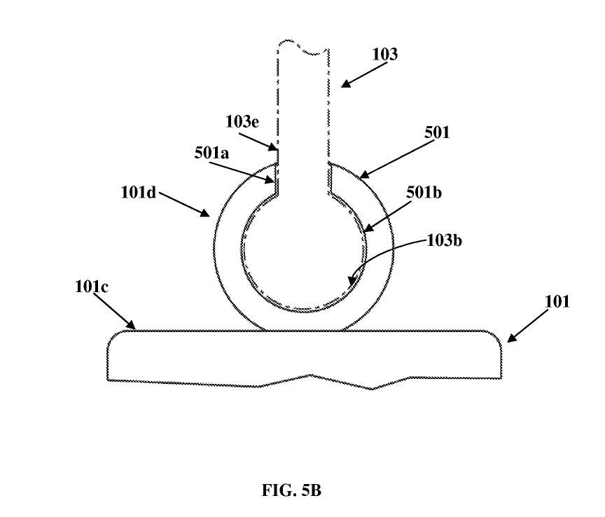

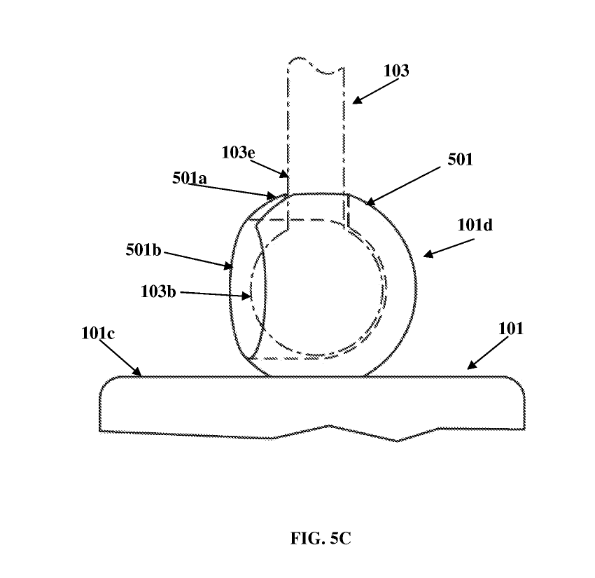

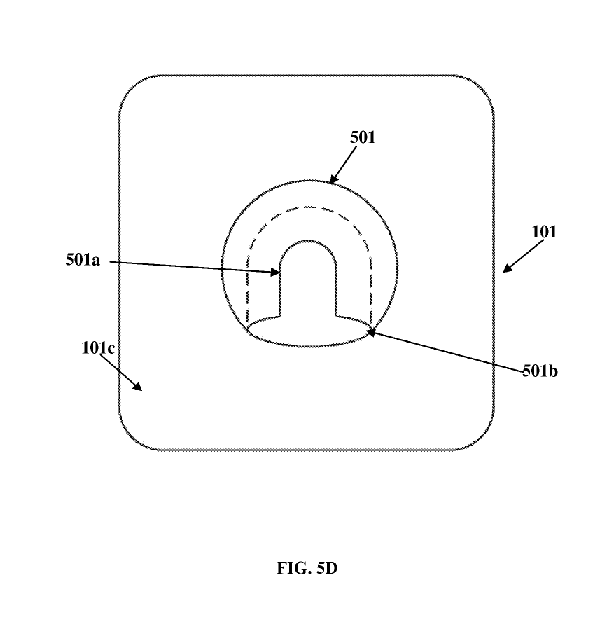

FIG. 5A exemplarily illustrates a perspective view of an embodiment of the ball socket 101d of the metal cap 101. FIG. 5B exemplarily illustrates a front elevation view of this embodiment of the ball socket 101d. FIG. 5C exemplarily illustrates a side elevation view of this embodiment of the ball socket 101d. FIG. 5D exemplarily illustrates a top view of this embodiment of the ball socket 101d. In this embodiment, the ball socket 101d is an enclosed socket or shell 501 all the way around with a slot 501a opening from the top and a circular opening 501b from the side. The enclosed shell 501 allows application of a significant pull force to pull the tooth 102 vertically from the alveolar bone socket 104. The rectilinear slot 501a is wide enough to allow the neck 103e of the transducer assembly 103 into the ball socket 101d but is narrower than the ball projection 103b. The circular opening 501b is wide enough to allow the ball projection 103b to fit inside the enclosed shell 501. In this manner, once the ball projection 103b is inserted from the circular opening 501b with the neck 103e passed into the slot 501a, the ball projection 103b is locked inside the enclosed shell 501. If the ball projection 103b is pulled from the top, the slot 501a blocks the ball projection 103b inside the enclosed shell 501, thus producing a pull force on the ball socket 101d. This type of metal cap 101 is made, for example, using stainless steel, and can be sterilized for reuse.

FIG. 6A exemplarily illustrates a side view of a transducer assembly 103 of the apparatus 100, showing a ball projection 103b extending from a transducer head 103a of the transducer assembly 103 in a linear configuration. The transducer assembly 103 comprises the transducer head 103a, the ball projection 103b extending from the transducer head 103a via the neck 103e of the transducer assembly 103, a trigger button 103d, and a battery compartment 103c. The ball projection 103b engages with the ball socket 101d on top of the removable metal cap 101 as exemplarily illustrated in FIG. 1B. The transducer head 103a produces the vibrations in the ball projection 103b at high frequencies that does not cause pain and discomfort to the tooth 102 being extracted. The trigger button 103d has, for example, high, low, and off options. An AA battery 103f, exemplarily illustrated in FIG. 1A, can be used in the battery compartment 103c to power the transducer assembly 103. Patients' tolerance to the frequency and magnitude of forces that can be applied on their teeth varies. The frequencies selected in the transducer assembly 103 and applied to the tooth 102 can be selected to be sedative and cause minimal discomfort. Modes of frequencies can be selected by using the trigger button 103d.

In an embodiment, the ball projection 103b of the transducer assembly 103 can be curved as exemplarily illustrated FIG. 6B. FIG. 6B exemplarily illustrates a side view of the transducer assembly 103 of the apparatus 100, showing the ball projection 103b extending from the transducer head 103a of the transducer assembly 103 in a curved configuration. In another embodiment, the ball projection 103b of the transducer assembly 103 can be angled as exemplarily illustrated in FIG. 6C. FIG. 6C exemplarily illustrates a side view of the transducer assembly 103 of the apparatus 100, showing the ball projection 103b extending from the transducer head 103a of the transducer assembly 103 in an angled configuration. The ball projection 103b can be used with all types of teeth 102. During the tooth removal procedure or the tooth loosening procedure, the ball projection 103b does not come in direct contact with the tooth 102 and can be used repetitively for subsequent removal or loosening of teeth. The ball projection 103b may need to be disinfected for reuse but not necessarily sterilized.

During normal chewing of food, the downwards and sideways forces exerted on the tooth 102 do not cause pain. However, if the tooth 102 is already loose or infected and is tender to touch, the tooth 102 should be examined by a dentist. In the absence of an infection, the only source of pain and discomfort would be forces that pull the tooth 102 away from the gum. The half open ball socket 101d disposed on the coronal surface 101c of the removable metal cap 101 is open at the front and the top, and allows the insertion of the ball projection 103b of the transducer assembly 103 into the ball socket 101d from the front. During a tooth removal procedure or a tooth loosening procedure, the ball projection 103b does not apply any pull force on the metal cap 101, since the metal cap 101 is open on the top. The only forces applied by the ball projection 103b to the metal cap 101, are downwards and sideways forces that are transmitted to the metal cap 101. Due to the small magnitude and high frequency of the forces applied by the ball projection 103b to the metal cap 101, the discomfort level would be similar to using an electrically operated tooth brush when cleaning teeth. Parents may expose the children to the vibration of an electrically operated tooth brush before the tooth removal procedure or the tooth loosening procedure to ensure them that the tooth removal procedure or the tooth loosening procedure will be similar to using the electrically operated tooth brush and comfortable.

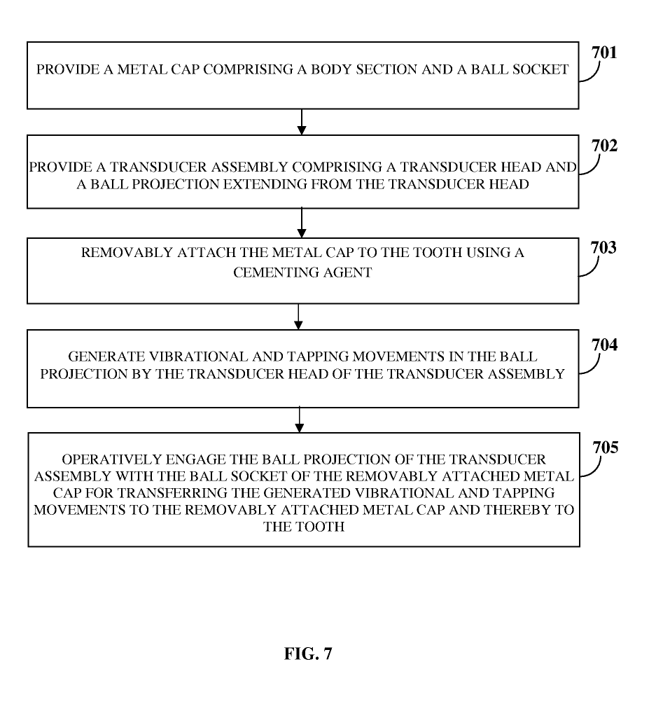

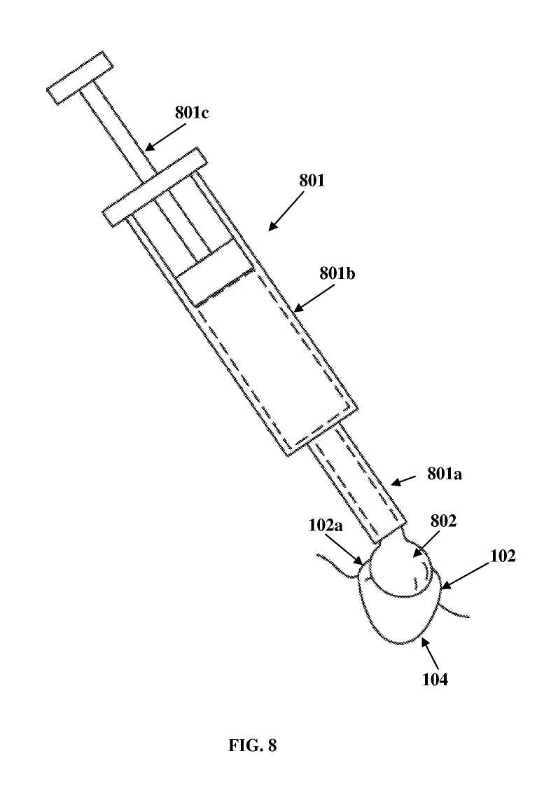

FIG. 7 exemplarily illustrates a method for rupturing connective tissues that attach a tooth 102 to an alveolar bone socket 104 of a patient. A metal cap 101 generally shaped like a crown 102a of the tooth 102, as disclosed in the detailed description of FIGS. 1A-2C, is provided 701. A transducer assembly 103 comprising a transducer head 103a and a ball projection 103b, as disclosed in the detailed description of FIGS. 1A-1B and FIGS. 6A-6C, is provided 702. The metal cap 101 is removably attached 703 to the tooth 102 using a cementing agent 802 exemplarily illustrated in FIG. 8. The transducer head 103a is activated to generate 704 vibrational and tapping movements in the ball projection 103b at a predetermined frequency, for example, of about 45 kHz. During a tooth removal procedure or a tooth loosening procedure, the ball projection 103b of the transducer assembly 103 is operatively engaged 705 with the ball socket 101d of the removably attached metal cap 101 for transferring the generated vibrational and tapping movements to the removably attached metal cap 101 and thereby to the tooth 102. The vibrational and tapping movements transferred to the tooth 102 by the transducer assembly 103 ruptures the connective tissues that attach the tooth 102 to the alveolar bone socket 104 of the patient thereby allowing the tooth 102 to be removed from the alveolar bone socket 104 with minimal pull force.

FIG. 8 exemplarily illustrates application of a cementing agent 802 on a tooth 102 using a mixing syringe 801. The mixing syringe 801 comprises a mixing tip 801a, a syringe cartridge 801b, and a syringe handle 801c. The cementing agent 802, for example, cement used herein is rigid and biologically safe for intra oral use. Many dental cement agents or materials can be used for cementing the metal cap 101 to the tooth 102. Most cementing agents require mixing of two fluidic materials in the mixing syringe 801 to form a rigid material. The mixing tip 801a is attached to the syringe cartridge 801b, for example, by a slide and twist-lock mechanism. When the syringe handle 801c is advanced forward, the cementing agent 802 is mixed through the mixing tip 801a. The mixing syringe 801 is used to load the mixed cementing agent 802 onto the primary tooth 102 and/or an inner surface of the removable metal cap 101, and the metal cap 101 is positioned over the primary tooth 102. The cementing agent 802 typically takes, for example, about two minutes to become rigid after application of the cementing agent 802 over the primary tooth 102. At the completion of the tooth removal procedure or the tooth loosening procedure, the apical strip and loop arrangement 101f of the metal cap 101 is severed at the soldered seal 203 exemplarily illustrated in FIG. 2A, to easily remove the soft metal cap 101 from the primary tooth 102. Since the primary tooth 102 is already loose, the removable metal cap 101 can generally be fitted easily over the primary tooth 102. The patient may be advised to fit the metal cap 101 over the primary tooth 102 without the cementing agent 802 first to ensure a smooth and accurate cementation. The method and apparatus 100 disclosed herein generally dislodges the primary tooth 102 from the alveolar bone socket 104 in a few minutes. If the patient experiences bleeding, the patient may be advised to bite on a sterile gauge or a tea bag to control the bleeding. An entire set of removable metal caps 101 for all types of primary teeth 102 may be made available over the counter. Representative pictures and videos can be used to help the patient or an operator to identify the correct matching removable metal cap 101 for the primary tooth 102 to be extracted.

Consider an example where a child patient has a loose primary molar tooth 102 that needs to be extracted. An adult user, for example, the parent of the patient selects a metal cap 101, as exemplarily illustrated in FIGS. 1A-2C, which matches the primary molar tooth 102. The user then applies the cementing agent 802, for example, a dental cement, either on the inner surface of the metal cap 101 or on the primary molar tooth 102 using the mixing syringe 801 as disclosed in the detailed description of FIG. 8. Before the cementing agent 802 becomes rigid, the user positions the metal cap 101 on the primary molar tooth 102 and allows the cementing agent 802 to set. After a few minutes, the adult user sets the transducer assembly 103 to a desired vibrational frequency mode, for example a frequency of about 45 kHz using the trigger button 103d of the transducer assembly 103, and engages the ball projection 103b of the transducer assembly 103 with the ball socket 101d disposed on the coronal surface 101c of the cemented metal cap 101 in situ inside the oral cavity of the patient. The user then powers the transducer assembly 103 to generate and transfer the vibrational and tapping movements at the desired frequency and force to the metal cap 101 through the ball projection-ball socket engagement, and in turn to the primary molar tooth 102 enclosed by the metal cap 101. At this point, the connective tissues, for example, the periodontal ligaments begin to rupture and within a few minutes the primary molar tooth 102 falls out of the alveolar bone socket 104 of the child patient. At the end of the procedure, the adult user can either lift the metal cap 101 directly from the front edge of the apical strip and loop arrangement 101f, or cut open the soldered seal 203 of the apical strip and loop arrangement 101f with a scissor. The apical strip and loop arrangement 101f is soldered together at the apical edge 202 to strengthen the integrity of the metal cap 101. The soldered seal 203 is not very strong and can be severed by applying a mild shearing force.

Although there may be difficulties for an inexperienced user to learn usage of the apparatus 100 disclosed herein, the benefit of overcoming weeks of discomfort and possibly avoiding the cost of visiting a dental office is a good incentive for a parent or an adult user to learn its usage. The method and apparatus 100 disclosed herein poses minimal risk to both the operator and the patient. In case of a failed attempt in removing the tooth 102, the soft nature of the metal cap 101 does not cause any health risk to the child patient. The apparatus 100 disclosed herein may be used by a layperson or a dentist for removing primary teeth and for loosening permanent teeth.

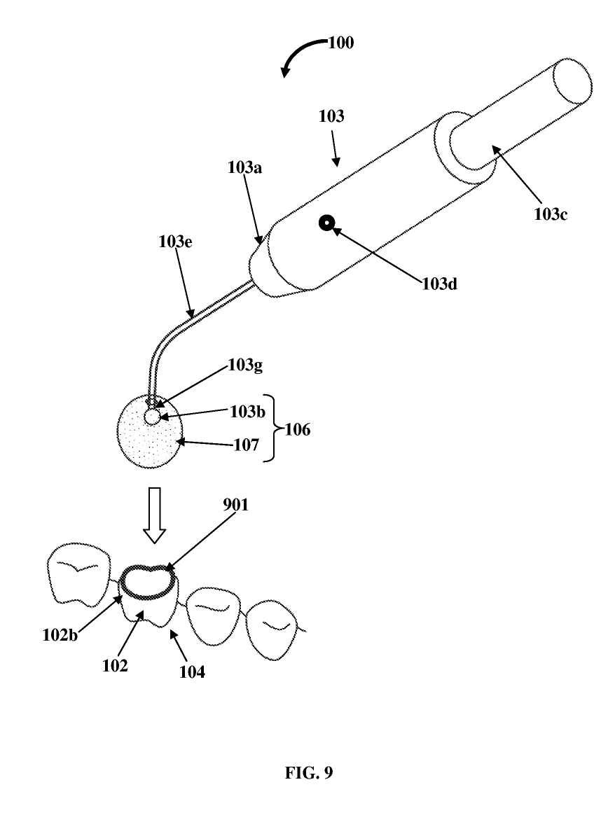

FIG. 9 exemplarily illustrates a perspective view of an embodiment of the apparatus 100 for rupturing connective tissues that attach a tooth 102, for example, a primary tooth, to an alveolar bone socket 104. In this embodiment, in addition to the transducer assembly 103 comprising the transducer head 103a and the battery compartment 103c, the apparatus 100 disclosed herein further comprises a motion transfer member 106. The transducer head 103a generates vibrational and tapping movements as disclosed in the detailed description of FIGS. 1A-1B. The transducer head 103a then transfers the generated vibrational and tapping movements to the motion transfer member 106 via the neck 103e of the transducer assembly 103. The motion transfer member 106 extends from the transducer head 103a via the neck 103e of the transducer assembly 103. The motion transfer member 106 comprises a ball projection 103b and a flexible member 107 of a predefined geometric shape, for example, a generally spherical shape as exemplarily illustrated in FIG. 9. The ball projection 103b is made, for example, of a metal such as stainless steel, or a plastic material with high rigidity to hold a pull force on the tooth 102. The ball projection 103b is operably connected to a distal end 103g of the neck 103e extending from the transducer head 103a. The ball projection 103b transfers the generated vibrational and tapping movements received from the transducer head 103a to the tooth 102.

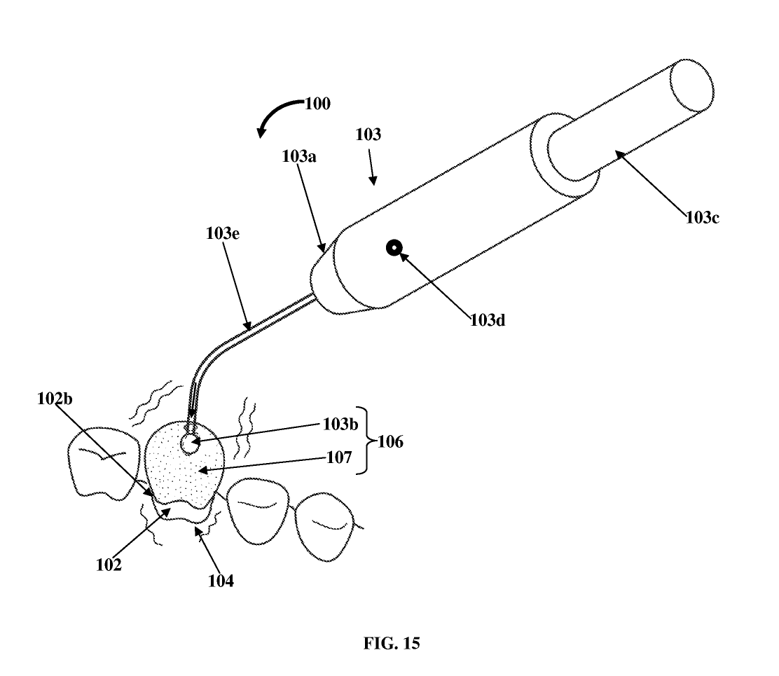

The flexible member 107 houses and surrounds the ball projection 103b. As used herein, “flexible member” refers to a foam based material or a non-foam based material that can generally conform to a shape of an object on which the flexible member 107 is placed and which can retain the deformed shape for a substantial amount of time. The flexible member 107 is made of one or more materials, for example, a medical grade foam such as polyurethane or another soft material that can reduce pain and transmit force. The flexible member 107 is configured to contact a surface 102b of the tooth 102 and generally conform to a shape of the tooth 102 to distribute the generated vibrational and tapping movements received from the ball projection 103b, uniformly in multiple directions on the tooth 102 as disclosed in the detailed description of FIG. 15. In an embodiment, the flexible member 107 made of non-foam based materials is used for distributing the generated vibrational and tapping movements uniformly in multiple directions on the tooth 102. The non-foam based materials comprise, for example, silicone rubber, ethylene propylene diene monomer (EPDM), or urethane rubber that can reduce pain and transmit force. The flexible member 107 can be, for example, sterilized by autoclaving or disposed after a single use. The flexible member 107, for example, functions as a buffer element to buffer and modulate force of the generated vibrational and tapping movements on the surface 102b of the tooth 102 to produce a soothing sensation on the surface 102b of the tooth 102 and on tissues surrounding the tooth 102.

The force from the vibrational and tapping movements generated from the transducer head 103a is buffered and modulated through the flexible member 107 to produce a numbing and soothing sensation over the surface 102b of the tooth 102. The uniformly distributed vibrational and tapping movements on the tooth 102 rupture the connective tissues that attach the tooth 102 to the alveolar bone socket 104 to allow the tooth 102 to be loosened and removed from the alveolar bone socket 104. When the connective tissues of the tooth 102, for example, the periodontal ligaments, rupture due to the uniformly distributed vibrational and tapping movements generated from the transducer head 103a, the tooth 102 is extracted from the alveolar bone socket 104.

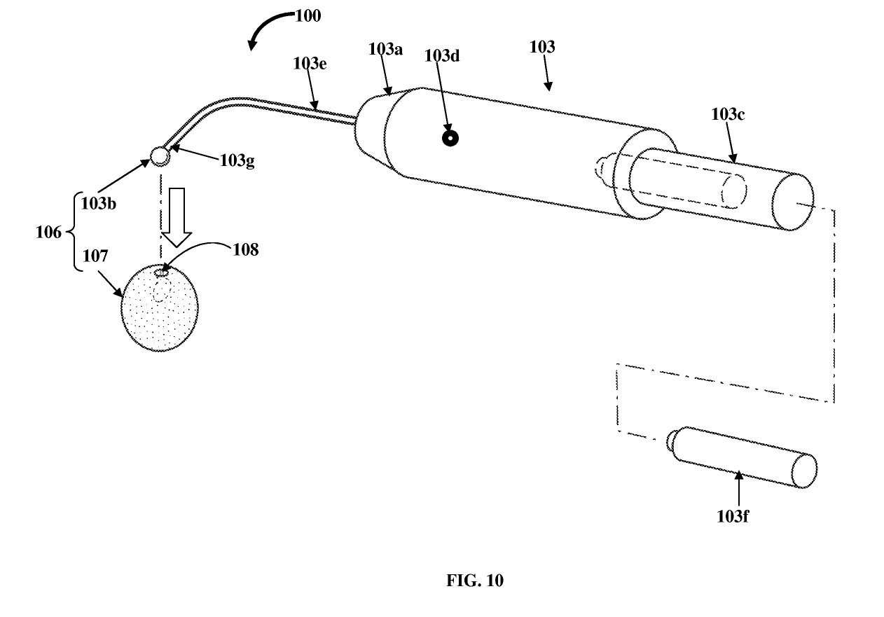

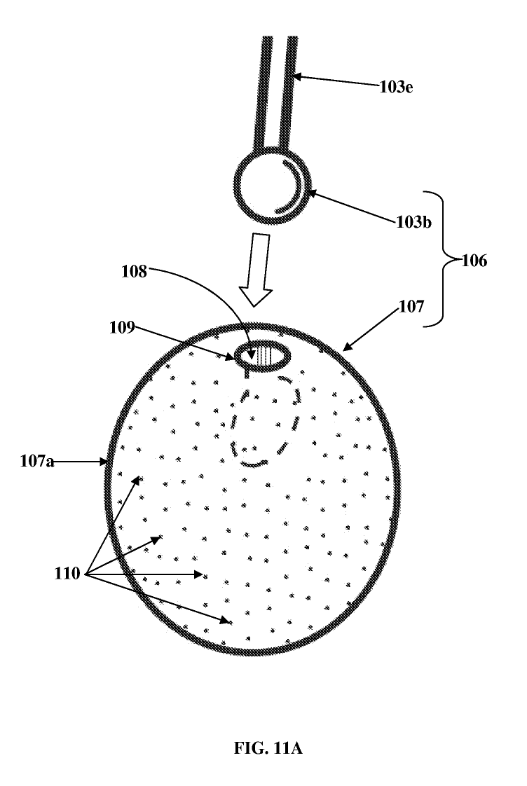

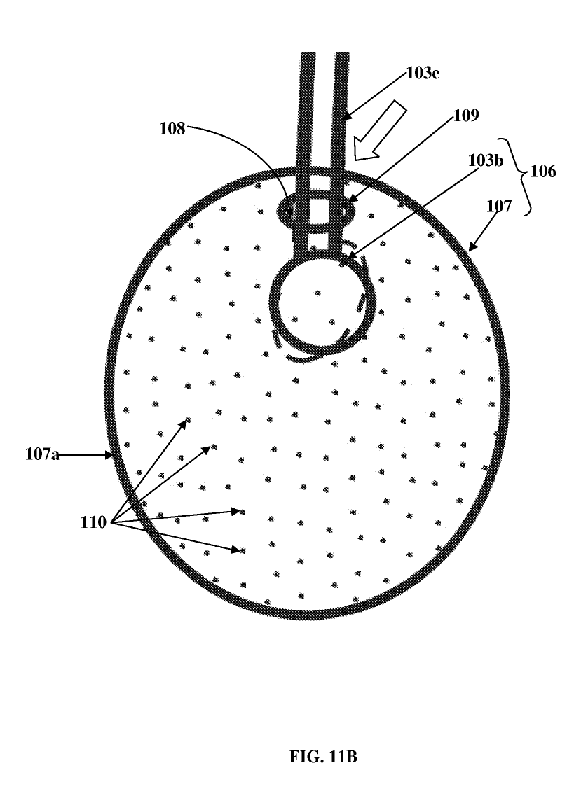

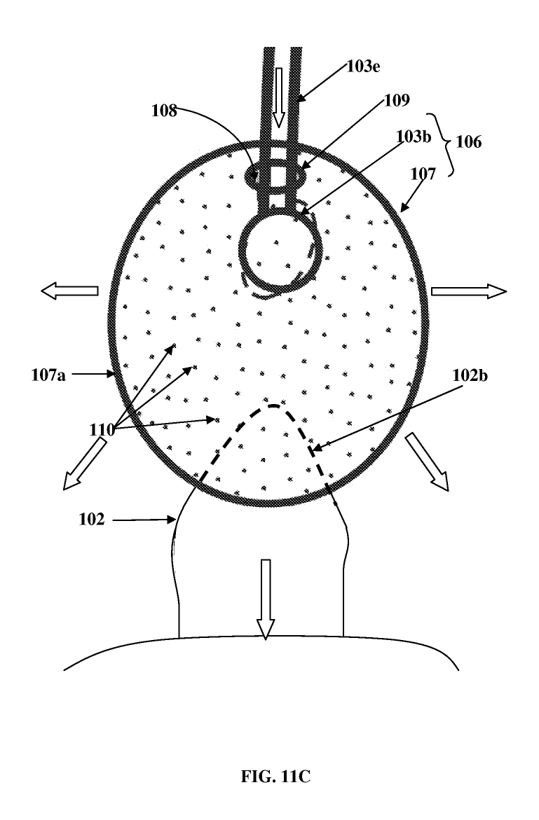

FIG. 10 exemplarily illustrates a partially disassembled view of the embodiment of the apparatus 100 shown in FIG. 9. The apparatus 100 disclosed herein comprises the transducer head 103a, the ball projection 103b extending from the transducer head 103a via the neck 103e, the battery compartment 103c that stores a battery 103f, and the flexible member 107 configured to house and surround the ball projection 103b to define the motion transfer member 106. The flexible member 107 comprises a receptacle 108 configured, for example, as a ball attachment, configured to receive the ball projection 103b as exemplarily illustrated in FIGS. 11A-11B. The battery 103f powers the transducer head 103a. In an embodiment, an AA battery 103f can be operably accommodated in the battery compartment 103c to power the transducer head 103a. A trigger button 103d is positioned on the transducer assembly 103. The trigger button 103d has, for example, high, low, and off options, to control the operation of the transducer head 103a. When the trigger button 103d is activated or switched on, the transducer head 103a produces vibrations at high frequencies and transfers the vibrations to the ball projection 103b via the neck 103e of the transducer assembly 103. The transducer head 103a therefore produces vibrations in the ball projection 103b at high frequencies. In an embodiment, the transducer head 103a generates vibrational and tapping movements at a predetermined frequency that minimizes pain and discomfort to a patient. The functioning of the flexible member 107 in communication with the ball projection 103b of the motion transfer member 106 is disclosed in the detailed description of FIGS. 11A-11B.

FIGS. 11A-11B exemplarily illustrate enlarged views of the motion transfer member 106 of the embodiment of the apparatus 100 shown in FIG. 9, showing connection of the ball projection 103b to the flexible member 107 of the motion transfer member 106. The flexible member 107 is, for example, of a generally spherical shape. The flexible member 107 comprises a receptacle 108 configured to receive and detachably connect to the ball projection 103b of the motion transfer member 106. The ball projection 103b is inserted into the receptacle 108 of the flexible member 107 through a flexible opening 109 of the receptacle 108 and locked inside the receptacle 108. The flexible opening 109 of the receptacle 108 expands when the ball projection 103b of the motion transfer member 106 is pushed through the flexible opening 109 into the receptacle 108. The ball projection 103b snap fits into the receptacle 108 of the flexible member 107, thereby connecting the ball projection 103b to the flexible member 107.

When the transducer assembly 103 exemplarily illustrated in FIG. 9, is activated, the vibrational movements produced in the transducer head 103a are transferred via the ball projection 103b to the flexible member 107 that contacts and generally conforms to the surface 102b and shape of the tooth 102 as exemplarily illustrated in FIG. 11C. In an embodiment, the motion transfer member 106 further comprises a mesh element 110 positioned on the outer surface 107a of the flexible member 107 for uniformly distributing the vibrational and tapping movements along the flexible member 107 to the surface 102b of the tooth 102 and on tissues surrounding the tooth 102 that are in contact with the flexible member 107. FIG. 11C exemplarily illustrates an enlarged view showing uniform distribution of vibrational movements on a tooth 102 by the motion transfer member 106. The force of the vibrational movements is transmitted uniformly in different directions as exemplarily indicated by block arrows in FIG. 11C, around the tooth 102. The force of the vibrational movements transferred through the mesh element 110 of the flexible member 107 is distributed in different directions and intensity due to a nonlinear elastic nature of the material of the flexible member 107.

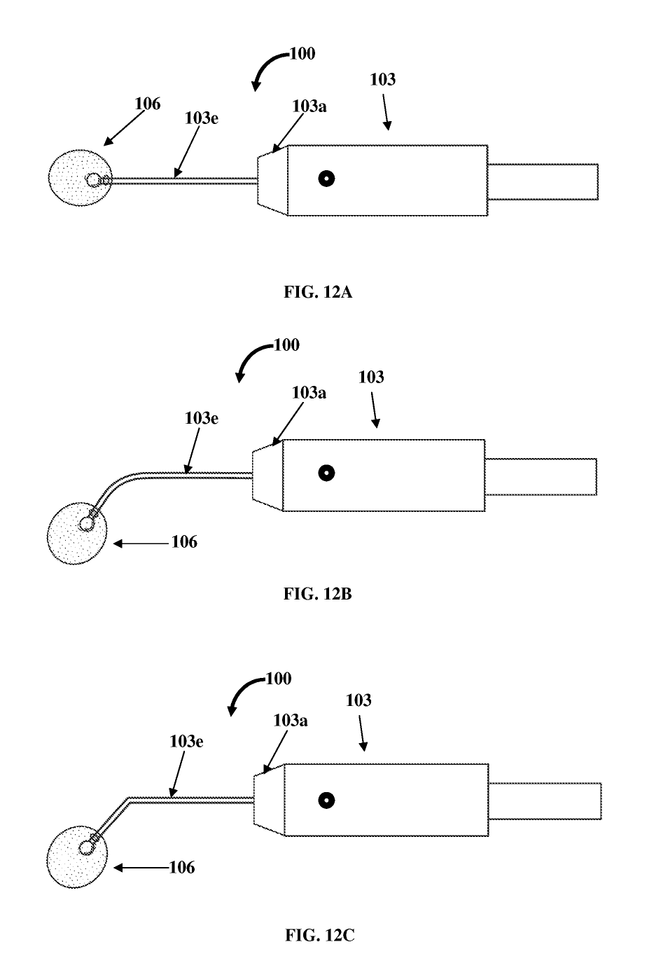

FIGS. 12A-12C exemplarily illustrate side views of the embodiment of the apparatus 100 shown in FIG. 9, showing different configurations of the motion transfer member 106 extending from the transducer head 103a. In an embodiment, the motion transfer member 106 is configured to extend from the transducer head 103a via the neck 103e of the transducer assembly 103 in a linear configuration as exemplarily illustrated in FIG. 12A. In another embodiment, the motion transfer member 106 is configured to extend from the transducer head 103a via the neck 103e of the transducer assembly 103 in a curved configuration as exemplarily illustrated in FIG. 12B. In another embodiment, the motion transfer member 106 is configured to extend from the transducer head 103a via the neck 103e of the transducer assembly 103 in an angled configuration as exemplarily illustrated in FIG. 12C.

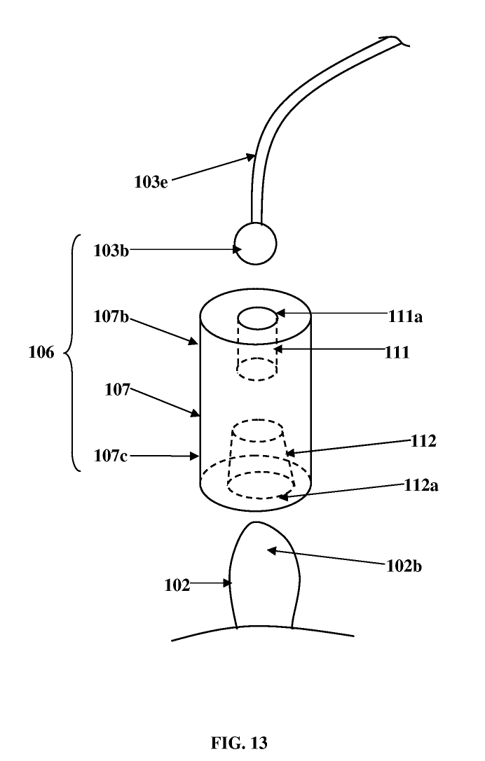

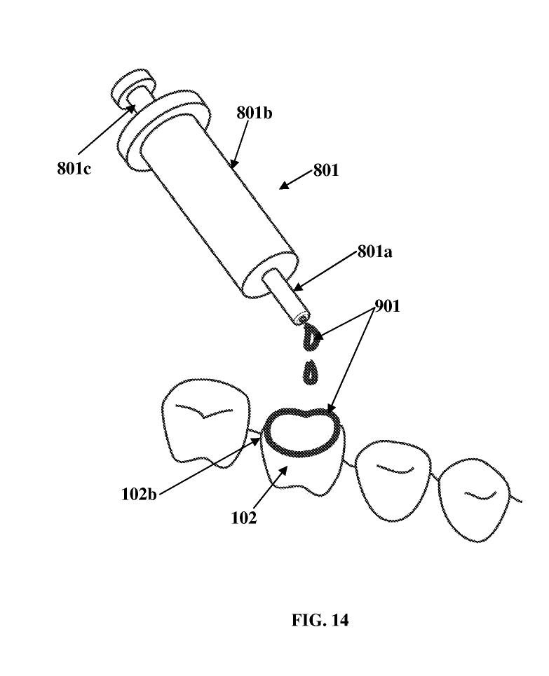

FIG. 13 exemplarily illustrates a partial perspective view of an embodiment of the motion transfer member 106 of the apparatus 100 shown in FIG. 9. In this embodiment, the flexible member 107 is, for example, of a generally cylindrical shape and comprises a first receptacle 111 positioned on an upper section 107b of the flexible member 107 and a second receptacle 112 positioned on a lower section 107c of the flexible member 107. The first receptacle 111 is configured to receive and detachably connect to the ball projection 103b of the motion transfer member 106. The first receptacle 111 is shaped, for example, in a cylindrical shape or a spherical shape to accommodate the ball projection 103b. The ball projection 103b is inserted into the first receptacle 111 of the flexible member 107 through a flexible opening 111a of the first receptacle 111 and locked inside the first receptacle 111. In an embodiment, the ball projection 103b is snap fit into the first receptacle 111. The first receptacle 111 houses and surrounds the ball projection 103b that extends from the transducer head 103a via the neck 103e of the transducer assembly 103 exemplarily illustrated in FIG. 9. The second receptacle 112 is configured to receive and contact the surface 102b of the tooth 102 and generally conform to the shape of the tooth 102. The second receptacle 112 is shaped, for example, in a trapezoidal shape to accommodate the tooth 102. The tooth 102 is received by the second receptacle 112 of the flexible member 107 through a flexible opening 112a of the second receptacle 112.

FIG. 14 exemplarily illustrates deposition of an adhesive material 901 on a surface 102b of a tooth 102 using a mixing syringe 801 prior to removal of the tooth 102. In an embodiment, the flexible member 107 of the motion transfer member 106 exemplarily illustrated in FIG. 9, is secured to the surface 102b of the tooth 102 using an adhesive material 901 deposited on the surface 102b of the tooth 102. An adhesive material 901, for example, a washable food based material, for example, polysaccharides, syrup, etc., is discharged from the mixing syringe 801 and deposited on the surface 102b of the tooth 102 to strengthen the bond between the flexible member 107 and the surface 102b of the tooth 102. The mixing syringe 801 comprises a mixing tip 801a, a syringe cartridge 801b, and a syringe handle 801c. The adhesive material 901 is stored in the syringe cartridge 801b. The mixing tip 801a is attached to the syringe cartridge 801b, for example, by a slide and twist-lock mechanism. The mixing tip 801a is used to mix at least two adhesive materials 901 or discharge a single adhesive material 901 in use. The adhesive materials 901 or dental cements used are, for example, zinc oxide eugenol which is a mixture of zinc oxide and eugenol in oil of cloves, or temporary adhesive materials 901, for example, Temp-Bond® of Kerr Corporation at 1717 West Collins Avenue, Orange, Calif. 92867. When the syringe handle 801c is advanced towards the mixing tip 801a, the adhesive material 901 is discharged through the mixing tip 801a and deposited on the surface 102b of the tooth 102.

FIG. 15 exemplarily illustrates a perspective view of the embodiment of the apparatus 100 shown in FIG. 9, operably connected to the tooth 102 to rupture the connective tissues that attach the tooth 102 to an alveolar bone socket 104. A user, for example, a dentist first connects the ball projection 103b that extends from the transducer head 103a of the transducer assembly 103 to the flexible member 107, so that the flexible member 107 houses and surrounds the ball projection 103b as exemplarily illustrated in FIG. 11B. The flexible member 107 and the ball projection 103b together constitute the motion transfer member 106. After the user connects the ball projection 103b to the flexible member 107, the user deposits an adhesive material 901 on the surface 102b of a patient's tooth 102 using the mixing syringe 801 exemplarily illustrated in FIG. 14. The user then positions the motion transfer member 106 of the apparatus 100 to contact the surface 102b of the tooth 102. The flexible member 107 of the motion transfer member 106 contacts the adhesive material 901 deposited on the surface 102b of the tooth 102, is therefore secured to the surface 102b of the tooth 102, and generally conforms to the shape the tooth 102. The flexible member 107 is wrapped around the tooth 102.

The user activates the trigger button 103d of the transducer assembly 103 to actuate the transducer head 103a to generate vibrational and tapping movements. The generated vibrational and tapping movements are transferred from the transducer head 103a to the ball projection 103b of the motion transfer member 106 via the neck 103e of the transducer assembly 103, and in turn to the flexible member 107 of the motion transfer member 106 that is secured to the surface 102b of the tooth 102. The motion transfer member 106 therefore transfers the generated vibrational and tapping movements to the tooth 102. The flexible member 107 connected and generally conforming to the shape of the tooth 102 allows the vibrational and tapping movements to be uniformly distributed in multiple directions on the tooth 102 so that connective tissues that attach the tooth 102 to the alveolar bone socket 104 are ruptured evenly. The uniform rupturing of the connective tissues of the tooth 102 allows the tooth 102 to be loosened and removed from the alveolar bone socket 104 of the patient with minimal pain and minimal discomfort to the patient.

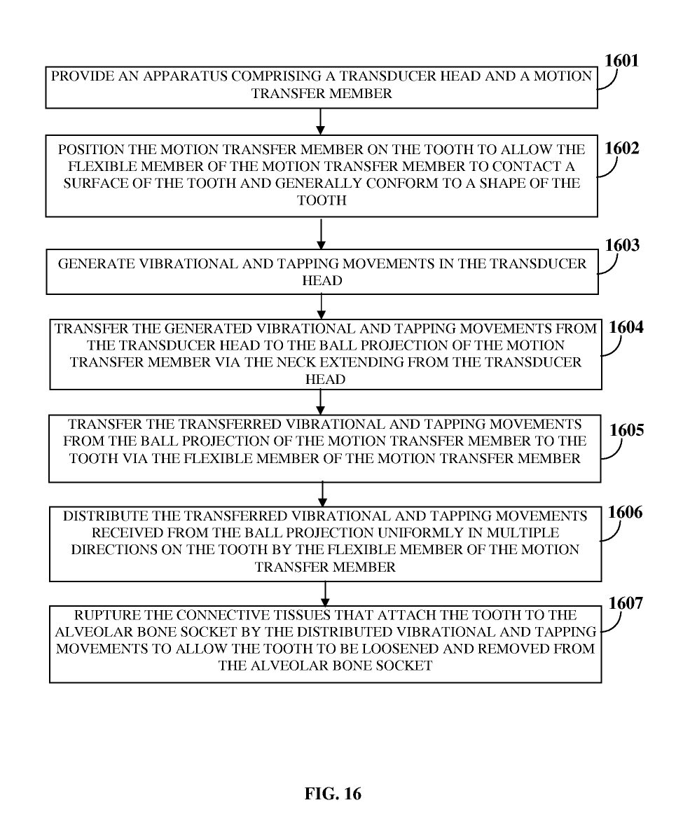

FIG. 16 exemplarily illustrates an embodiment of the method for rupturing connective tissues that attach a tooth 102 to an alveolar bone socket 104 exemplarily illustrated in FIG. 9. An apparatus 100 comprising the transducer head 103a and the motion transfer member 106 as exemplarily illustrated in FIG. 9 and as disclosed in the detailed description of FIG. 9, is provided 1601. The motion transfer member 106 comprising the ball projection 103b and the flexible member 107 is positioned 1602 on the tooth 102 to allow the flexible member 107 to contact the surface 102b of the tooth 102 and generally conform to the shape of the tooth 102. In an embodiment, an adhesive material 901 is discharged from the mixing syringe 801 exemplarily illustrated in FIG. 14, and deposited on the surface 102b of the tooth 102 to secure the flexible member 107 to the tooth 102. The transducer head 103a generates 1603 vibrational and tapping movements. The vibrational and tapping movements generated in the transducer head 103a are transferred 1604 from the transducer head 103a to the ball projection 103b of the motion transfer member 106 via the neck 103e of the transducer assembly 103.

The flexible member 107 transfers 1605 the transferred vibrational and tapping movements from the ball projection 103b of the motion transfer member 106 to the tooth 102. The flexible member 107 distributes 1606 the transferred vibrational and tapping movements received from the ball projection 103b uniformly in multiple directions on the tooth 102. The distributed vibrational and tapping movements from the transducer head 103a to the flexible member 107 via the ball projection 103b ruptures 1607 the connective tissues that attach the tooth 102 to the alveolar bone socket 104 to allow the tooth 102 to be loosened and removed from the alveolar bone socket 104.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. An apparatus for rupturing connective tissues that attach a tooth to an alveolar bone socket, said apparatus comprising:
a transducer head configured to generate vibrational and tapping movements, and transfer said generated vibrational and tapping movements to a motion transfer member via a neck of a transducer assembly; and
said motion transfer member extending from said transducer head via said neck of said transducer assembly, said motion transfer member comprising:
a ball projection operably connected to a distal end of said neck extending from said transducer head, said ball projection configured to transfer said generated vibrational and tapping movements received from said transducer head to said tooth; and
a flexible member of a predefined shape configured to house and surround said ball projection, said flexible member further configured to contact a surface of said tooth and generally conform to a shape of said tooth to distribute said generated vibrational and tapping movements received from said ball projection, uniformly in a plurality of directions on said tooth to rupture said connective tissues that attach said tooth to said alveolar bone socket to allow said tooth to be loosened and removed from said alveolar bone socket.

2. The apparatus of claim 1, wherein said predefined shape of said flexible member of said motion transfer member is of a geometric shape comprising one of a generally spherical shape and a generally cylindrical shape.

3. The apparatus of claim 1, wherein said flexible member of said motion transfer member comprises a receptacle positioned on an upper section of said flexible member, wherein said receptacle is configured to receive and detachably connect to said ball projection of said motion transfer member.

4. The apparatus of claim 3, wherein said ball projection is inserted into said receptacle of said flexible member through a flexible opening of said receptacle and locked inside said receptacle.

5. The apparatus of claim 1, wherein said flexible member of said motion transfer member comprises a receptacle positioned on a lower section of said flexible member, wherein said receptacle is configured to receive and contact said tooth and generally conform to said shape of said tooth.

6. The apparatus of claim 5, wherein said tooth is received by said receptacle of said flexible member through a flexible opening of said receptacle.

7. The apparatus of claim 1, wherein said motion transfer member is configured to extend from said transducer head via said neck of said transducer assembly in one of a linear configuration, a curved configuration, and an angled configuration.

8. The apparatus of claim 1, wherein said transducer head is configured to generate said vibrational and tapping movements at a predetermined frequency.

9. The apparatus of claim 1, wherein said flexible member of said motion transfer member is further configured to buffer and modulate force of said generated vibrational and tapping movements on said surface of said tooth to produce a soothing sensation on said surface of said tooth and on tissues surrounding said tooth.

10. The apparatus of claim 1, wherein said motion transfer member further comprises a mesh element positioned on an outer surface of said flexible member, wherein said mesh element is configured to distribute said generated vibrational and tapping movements along said flexible member to said surface of said tooth and on tissues surrounding said tooth that are in contact with said flexible member.

11. The apparatus of claim 1, wherein said flexible member of said motion transfer member is secured to said surface of said tooth using an adhesive material deposited on said surface of said tooth.

12. The apparatus of claim 11, wherein said adhesive material is a washable food based material.

13. A motion transfer member for transferring vibrational and tapping movements from a transducer head of a transducer assembly to a tooth to rupture connective tissues that attach said tooth to an alveolar bone socket, said motion transfer member comprising:
a ball projection operably connected to a distal end of a neck extending from said transducer head of said transducer assembly, said ball projection configured to transfer said generated vibrational and tapping movements received from said transducer head to said tooth; and
a flexible member of a predefined shape configured to house and surround said ball projection, said flexible member further configured to contact a surface of said tooth and generally conform to a shape of said tooth to distribute said generated vibrational and tapping movements received from said ball projection, uniformly in a plurality of directions on said tooth to rupture said connective tissues that attach said tooth to said alveolar bone socket to allow said tooth to be loosened and removed from said alveolar bone socket.

14. The motion transfer member of claim 13, wherein said predefined shape of said flexible member is of a geometric shape comprising one of a generally spherical shape and a generally cylindrical shape.

15. The motion transfer member of claim 13, wherein said flexible member comprises a receptacle positioned on an upper section of said flexible member, wherein said receptacle is configured to receive and detachably connect to said ball projection, and wherein said ball projection is inserted into said receptacle through a flexible opening of said receptacle and locked inside said receptacle.

16. The motion transfer member of claim 13, wherein said flexible member comprises a receptacle positioned on a lower section of said flexible member, wherein said receptacle is configured to receive and contact said tooth and generally conform to said shape of said tooth, and wherein said tooth is received by said receptacle of said flexible member through a flexible opening of said receptacle.

17. The motion transfer member of claim 13, further comprising a mesh element positioned on an outer surface of said flexible member, wherein said mesh element is configured to distribute said generated vibrational and tapping movements along said flexible member to said surface of said tooth and on tissues surrounding said tooth that are in contact with said flexible member.

18. The motion transfer member of claim 13 configured to extend from said transducer head via said neck of said transducer assembly in one of a linear configuration, a curved configuration, and an angled configuration.

19. The motion transfer member of claim 13, wherein said flexible member is further configured to buffer and modulate force of said generated vibrational and tapping movements on said surface of said tooth to produce a soothing sensation on said surface of said tooth and on tissues surrounding said tooth.

20. A method for rupturing connective tissues that attach a tooth to an alveolar bone socket, said method comprising:
providing an apparatus comprising:
a transducer head; and
a motion transfer member extending from said transducer head via a neck of a transducer assembly, said motion transfer member comprising:
a ball projection operably connected to a distal end of said neck extending from said transducer head; and
a flexible member of a predefined shape configured to house and surround said ball projection;
positioning said motion transfer member on said tooth to allow said flexible member of said motion transfer member to contact a surface of said tooth and generally conform to a shape of said tooth;
generating vibrational and tapping movements in said transducer head;
transferring said generated vibrational and tapping movements from said transducer head to said ball projection of said motion transfer member via said neck extending from said transducer head;
transferring said transferred vibrational and tapping movements from said ball projection of said motion transfer member to said tooth via said flexible member of said motion transfer member;
distributing said transferred vibrational and tapping movements received from said ball projection uniformly in a plurality of directions on said tooth by said flexible member of said motion transfer member; and
rupturing said connective tissues that attach said tooth to said alveolar bone socket by said distributed vibrational and tapping movements to allow said tooth to be loosened and removed from said alveolar bone socket.

21. The method of claim 20, wherein said predefined shape of said flexible member of said motion transfer member is of a geometric shape comprising one of a generally spherical shape and a generally cylindrical shape.

22. The method of claim 20, further comprising securing said flexible member of said motion transfer member to said surface of said tooth using an adhesive material deposited on said surface of said tooth.

23. The method of claim 20, wherein said flexible member of said motion transfer member comprises a receptacle positioned on an upper section of said flexible member, wherein said receptacle is configured to receive and detachably connect to said ball projection of said motion transfer member, and wherein said ball projection is inserted into said receptacle through a flexible opening of said receptacle and locked inside said receptacle.

24. The method of claim 20, wherein said flexible member of said motion transfer member comprises a receptacle positioned on a lower section of said flexible member, wherein said receptacle is configured to receive and contact said tooth and generally conform to said shape of said tooth, and wherein said tooth is received by said receptacle through a flexible opening of said receptacle.

25. The method of claim 20, wherein said motion transfer member is configured to extend from said transducer head via said neck of said transducer assembly in one of a linear configuration, a curved configuration, and an angled configuration.

26. The method of claim 20, wherein said motion transfer member further comprises a mesh element positioned on an outer surface of said flexible member of said motion transfer member, wherein said mesh element is configured to distribute said generated vibrational and tapping movements along said flexible member to said surface of said tooth and on tissues surrounding said tooth that are in contact with said flexible member.

27. The method of claim 20, wherein said transducer head is configured to generate said vibrational and tapping movements at a predetermined frequency.

28. The method of claim 20, wherein said flexible member of said motion transfer member is further configured to buffer and modulate force of said generated vibrational and tapping movements on said surface of said tooth to produce a soothing sensation on said surface of said tooth and on tissues surrounding said tooth.
